(19) United States
(12) Patent Application Publication
(10) Pub. No.: US 2016/0081303 A1
(43) Pub. Date: Mar. 24, 2016

(54) PET BALL TOY WITH INTERNALLY MOUNTED SQUEAKER AND METHOD OF CONSTRUCTION

(71) Applicant: David F. Simon, Lakeland, FL (US)

(72) Inventor: David F. Simon, Lakeland, FL (US)

(21) Appl. No.: 14/552,527

(22) Filed: Nov. 25, 2014

Related U.S. Application Data
(60) Provisional application No. 62/052,030, filed on Sep. 18, 2014.

(51) Int. Cl. A01K 15/02; B29C 65/00

(52) U.S. Cl. CPC A01K 15/025; B29C 65/002; B29L 2031/54

(57) ABSTRACT

A hollow pet toy has a squeaker installed in a hole in a squeaker housing molded into the inside of one of two cupped ball toy parts formed with a hole therein receiving a squeaker, with an air vent hole extending in from the one ball exterior connecting to the squeaker housing hole to allow air flow in and out of the squeaker as the ball toy is compressed and released by the pet.

### CROSS REFERENCE TO RELATED APPLICATIONS

This application claims the benefit of U.S. provisional application No. 62/052,030 filed on Sep. 18, 2014.

### BACKGROUND OF THE INVENTION

This invention concerns pet toys and specifically ball toys equipped with a squeaker, a device which produces squeaking sounds as the pet bites and releases the ball toy.

The high pitched sound of a squeaker resembles a distress call of a prey animal such as a mouse, triggering the predator instinct of some pet dogs.

Such squeaker devices are well known and commercially available, comprised of a squeaker tube enclosing a reed, made of a thin strip of a flexible material. The reed is fixed at one end to an end of the tube, extending along the inside of the tube towards the other end. When air is induced to flow through the tube in either direction, the reed vibrates and generates the high pitched squeaking sound.

The tube of the squeaker is conventionally mounted to extend radially through a hole in an outer wall defining the shape of the ball toy. When the pet bites down on the ball toy, the ball is partially collapsed and air is forced out through the tube and a squeaking sound is produced by vibration of the reed in the squeaker. When the ball toy is released by the pet, the ball toy returns to its uncompressed spherical shape and air is drawn back in through the squeaker tube, the reed again producing the squeaking sound.

Major durability problems with the squeaker have occurred in conventional ball toys including a squeaker due to the often vigorous biting of such ball toys by a pet dog in attempting to subdue the “prey”, which often severely damages the squeaker by crushing the squeaker, or by a pet's tooth entering an air vent hole and penetrating the squeaker tube, damaging the reed or the reed mounting.

Conventionally, the squeaker tube is inserted endwise into the air vent hole extending from the exterior of the ball toy interior. The squeaker is affixed in this position by a flange formed on the outer end of the squeaker tube, the flange bonded to the surrounding ball toy exterior. A felt covering is typically applied over the ball exterior after the squeaker is installed so that the squeaker flange is likewise covered with felt.

As noted above, this arrangement has the disadvantage of subjecting the squeaker to damage when the pet bites down on the ball as this may crush the squeaker. A dog's tooth can also enter the squeaker tube and damage the squeaker reed or its mounting.

The squeaker can also be pulled out from the hole in the ball as a result of the pet's activity in chewing on the ball toy.

It is an object of the present invention to provide a ball toy or other hollow pet toy with a squeaker device which is mounted so as to be substantially less vulnerable to damage from a pet biting or chewing on the ball toy exterior.

It is a further object to provide a hollow ball toy having a squeaker device mounting which better resists dislodgment of the squeaker as from the ball toy.

It is another object to provide a mounting method for the squeaker in a ball toy which is simple and inexpensive to carry out.

### SUMMARY OF THE INVENTION

The above cited objects and other objects which will be understood on reading the following specification and claims are achieved by mounting a squeaker within a squeaker housing which is molded integrally with the inside of one of two separately molded cupped ball toy parts to be disposed completely within the ball toy when the parts are joined together to form the ball toy.

The molded in squeaker housing projects from the inside of one of the ball parts, the housing having a through hole molded therein extending from a portion of the housing exposed within the one cupped ball toy part towards the exterior of the ball part and of a length able to accommodate the squeaker tube when the squeaker tube is inserted in the housing hole. A flange on the squeaker tube is seated on the inside portion of the housing to be reversely oriented from conventional ball toy mounting so as to not be able to be pulled out from the exterior of the ball.

The two cupped ball parts are thereafter joined together along respective rim edges thereof to form the completed ball toy, which may thereafter be covered with a felt cover layer to produce a pet toy ball similar in appearance to a tennis ball.

The squeaker housing has portions around the hole sufficiently thick to reinforce the protection afforded by the wall defining of the ball toy itself so as to provide substantially greater protection of a squeaker inserted therein against being crushed by a pet dog biting on the ball toy exterior.

The integrally molded squeaker housing is preferably located off center extending radially in from the interior of the wall of the ball to be long enough so that the length of the hole formed therein accommodates the entire length of the squeaker tube completely enclosed therein.

An inlet/venting air hole is formed extending in from the ball toy exterior and in communication with the squeaker housing hole to allow air flow in and out of the squeaker tube when the ball toy is partially collapsed by the dog biting on the ball exterior and then released allowing it to again assume its spherical shape.

As noted, the surrounding mass of the molded material defining the squeaker housing is made sufficiently thick, on the order of the thickness of the ball toy part wall to provide adequate protection for the squeaker against crushing damage inflicted by the pet in biting and chewing on the ball toy exterior.

To install, the squeaker tube is simply inserted into the hole opening entering into the squeaker housing from the inside of the ball toy with no further assembly steps required. Anchoring barbs in the squeaker tube hold the tube in position within the hole in the molded in squeaker housing, with the flange seated on the inside expose portion of the squeaker housing extending around the squeaker tube hole entrance.

The ball toy separate parts are thereafter joined together along outer rim edges as by a vulcanization process. A two part felt cover may then be applied as by use of an adhesive to create a squeaker ball toy resembling a tennis ball.

The squeaker is constructed of a durable plastic material known in the art but which can resist the temperatures involved in bonding the two ball toy parts together.

The squeaker housing may be located offset from center of the ball and of a sufficient mass to create an imbalance of the ball toy causing an erratic rolling of the ball toy to increase the interest of the pet in fetching or playing with the ball.

### DESCRIPTION OF THE DRAWING FIGURES

FIG. 1 is an external view of a pet ball toy according to the invention.

FIG. 2 is a sectional view of the ball toy shown in FIG. 1 showing the separately molded ball parts.

FIG. 3 is a fragmentary top view of one of the ball toy parts showing the position of a integrally formed squeaker housing feature in which a squeaker has been installed.

FIGS. 4 and 5 are sectional views of different sized toy balls showing the varying location of the squeaker housing for each size of ball toy.

FIG. 6 is a sectional view of one of the ball toy parts showing the details of a squeaker housing integrally molded therewith.

FIG. 7 is an enlarged fragmentary sectional view of the toy ball part shown in FIG. 6

FIG. 8 is an exploded sectional view of the two cupped ball toy parts which are bonded together to form the completed ball toy with a squeaker installed.

FIG. 9 is a sectional view of an alternate embodiment of a ball toy according to the invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the drawings and particularly FIGS. 1-3, a hollow toy such as a ball toy 10 is shown, which may optionally have an outer felt covering 12 (this material known in the art as terylene) applied by installing two FIG. 8 covering pieces 12A, 12B in the well known manner to resemble a conventional tennis ball.

The ball toy 10 comprises two cupped ball toy parts 14A, 14B, each defined by an outer wall 15A, 15B, each molded separately from the other, from a suitable tough elastomeric material well known in the field able to withstand biting and sustained chewing by a dog. The parts 14A, 14B are bonded together along respective abutting rim edges 16A, 16B (FIG. 8) which are thickened at the rims 16A, 16B as shown compared to the remaining outer wall thickness to improve the strength of the bond. This bonding is preferably carried out by vulcanization of the elastomeric material in the known manner.

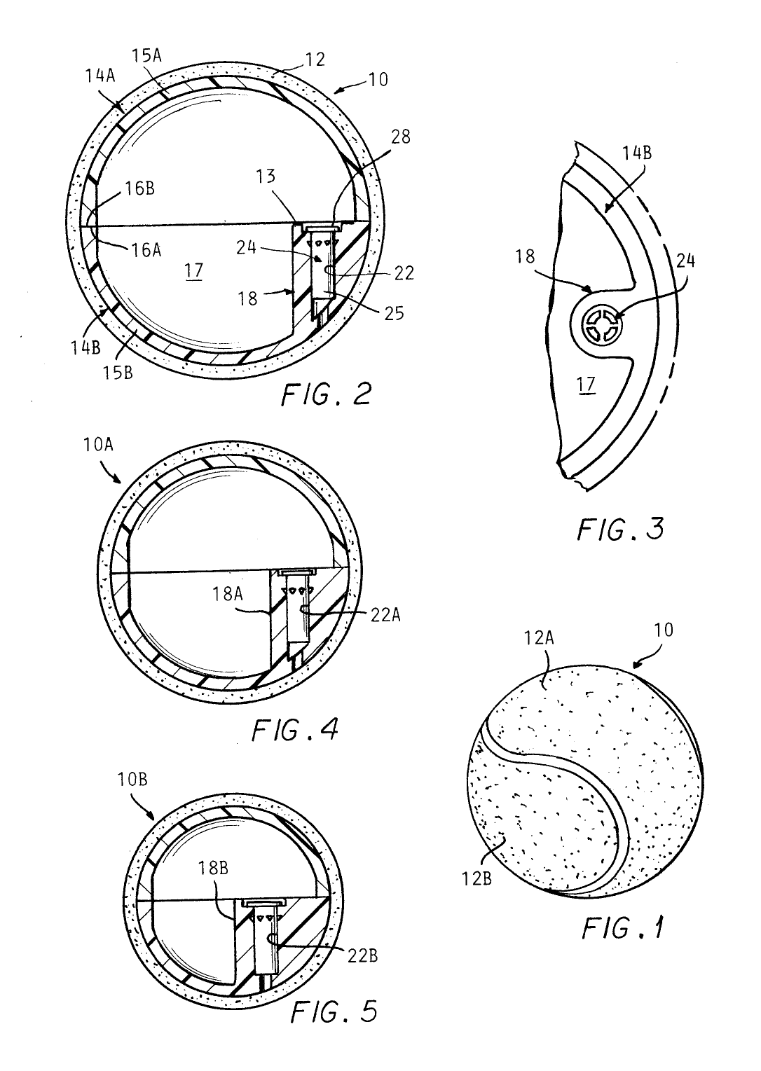

As shown in FIGS. 2 and 3, a squeaker housing 18 is integrally molded into the inside wall 15B of one of the two ball toy parts 14B. The squeaker housing 18 preferably projects radially inward from the inside 17 of a ball toy wall 20B in the one ball toy part 14B.

A hole 22 is molded into the squeaker housing 18 of a diameter to slidably receive a tube 25 of a squeaker 24 entering into the housing 18 from a portion 13 exposed within the inside 17 thereof. The hole 22 extends from the entry end thereof in a direction towards the ball toy exterior.

The length of the hole 22 is preferably sufficient to accommodate the entire length of the squeaker 24.

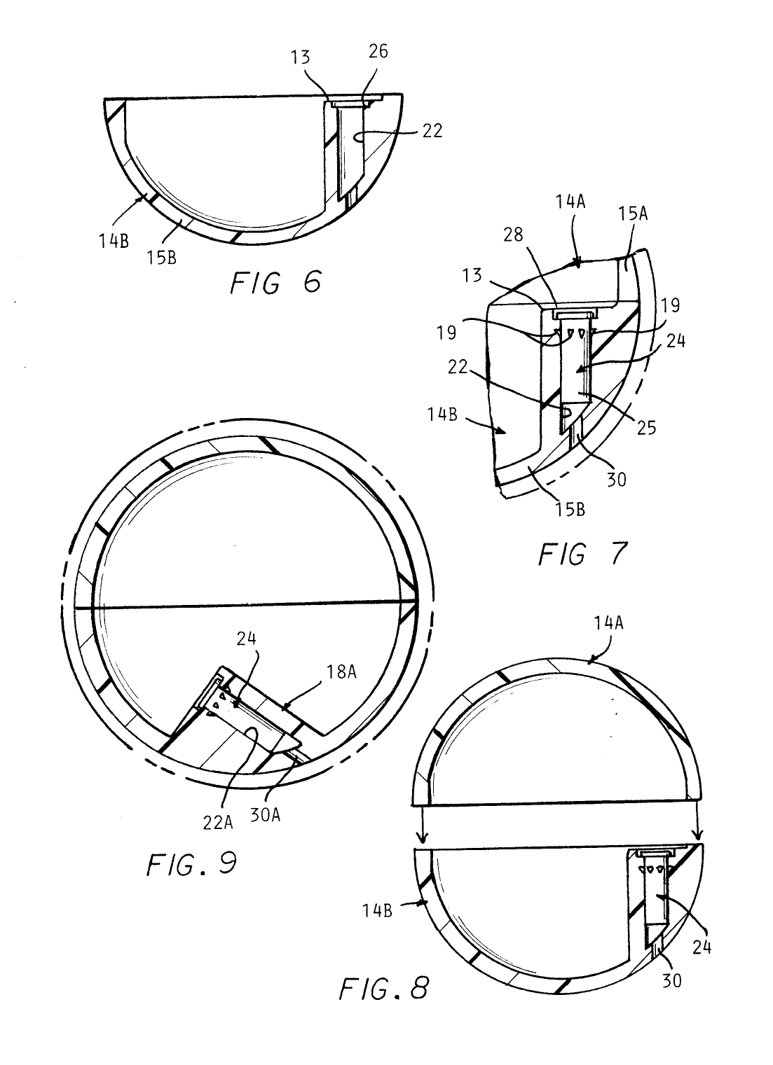

As best seen in FIG. 6, a counterbore 26 is located at the entry end of the hole 22, the counterbore 26 receiving a flange 28 located at the top of the squeaker tube 25 and abutting the housing surface surrounding the hole 22.

According to the present invention, the squeaker tube 25 is inserted into the entry end of the hole 22 when the squeaker 24 is installed in the housing 18, prior to the bonding of the two ball toy parts 14A, 14B together. Barbs 19 on the squeaker tube 25 secure the squeaker 24 in the hole 22.

The squeaker 24 is made of a known material able to withstand the high temperatures of the vulcanization.

The minimum wall thickness of the housing 18 is made thick enough, i.e., advantageously about the same thickness as the walls 15A, 15B (approximately 3 mm) defining each ball toy part 14A, 14B so as to substantially reinforce the walls 15A, 15B of the ball parts 14A. 14B and substantially improve the protection for the squeaker 24 against its being crushed by the chewing and biting of the pet toy 10 by a pet, preferably to more than double the protection of the squeaker 24 assembled therein.

The eccentrically located squeaker housing 18 also may be sufficiently heavy to create a pronounced irregular rolling to create an additional chase interest for the pet dog.

An air inlet/outlet hole 30 extends in from the exterior of the ball toy part 14B and is in communication with the squeaker receiving hole 22. This will space the squeaker 24 from the exterior of the ball toy 10 to minimize the chances that a dog's tooth could reach and damage the squeaker 24 since it is thereby recessed well away from the ball toy exterior.

Also, the squeaker flange 28 is thereby located away from the exterior of the ball toy 10, which is a reverse orientation from conventional construction, which better protects the reed mounting which is located at the flange end of the squeaker 24 from the dog's tooth.

The sideways orientation of the squeaker 24 with respect to the exterior of the ball toy 10 also substantially improves the ability of the squeaker 24 to withstand biting and chewing when compared to the endwise conventional mounting.

The diameter of the ball toy 10 may be varied to suit different sized dogs, as shown in FIGS. 4 and 5. The smaller diameters may require that the location of the squeaker housing hole 22B be shifted towards the center of the ball toy 10 as seen in FIGS. 4 and 5 to accommodate the full length of the squeaker housing 18.

It may be advantageous to incline the squeaker housing 18A with respect to the inlet/outlet air vent hole 30A so as to reduce the chance that a dog's tooth entering the air vent hole 30A will come into contact with the squeaker 24 as it is directed to one side of the squeaker 24 as shown in FIG. 9.

Accordingly a greatly reduced vulnerability to squeaker damage will result from the ball toy 10 mounting described herein while still minimizing manufacturing costs, and providing an irregular rolling motion of the ball toy 10.

Other hollow toys than balls with squeakers can also benefit from this mounting technique.

1. A ball toy combined with a squeaker comprising:
a pair of cupped ball toy parts formed of a resiliently compressible material, said ball toy parts joined together along respective abutting rim edges thereof to form the ball toy;
one of said cupped ball toy parts having an integral housing extending inwardly from the inside of said one of said cupped ball toy parts;
a squeaker receiving hole configured to receive and substantially enclose a squeaker, said squeaker receiving hole extending through said integral housing, said squeaker receiving hole having an entry end entering into a portion of said housing exposed within said cupped one ball toy part;
an air vent hole extending in from an outside of said one ball toy part and in communication with an end of said squeaker receiving hole opposite said entry end thereof; and
said squeaker tube installed into said squeaker receiving hole from said entry end thereof to be able to direct air out through said air vent hole when said ball toy is compressed and to receive air inflow through said air vent hole when said ball toy springs back to shape after being compressed.

2. The squeaker toy according to claim 1 wherein said squeaker tube has a flange at one end abutting a surface of said housing extending around said entry end of said squeaker receiving hole.

3. The squeaker toy according to claim 1 wherein said integral housing exposed portion is substantially aligned with a rim of said one of said ball toy parts.

4. The ball toy according to claim 1 wherein said housing squeaker receiving hole is of a length able to completely enclose said squeaker tube.

5. The squeaker toy according to claim 1 wherein said squeaker receiving hole in said squeaker housing extends at an angle to said air vent hole to thereby direct a pet's tooth penetrating into said air vent hole away from said squeaker in said squeaker receiving hole.

6. A method of constructing a hollow ball toy having a squeaker built in comprising:
separately molding a pair of cupped ball toy parts;
molding a projecting squeaker housing to an inside of one of said cupped ball toy parts; with said squeaker housing having a through hole therein which is configured to slidably receive a tube of a squeaker, said squeaker receiving hole having an entry end entering a squeaker housing portion exposed within said one cupped ball toy part;
forming an air vent hole extending into said outside of said one of said cupped ball toy parts and in communication with an end of said squeaker receiving hole opposite said entry end thereof;
installing a squeaker in said housing squeaker receiving hole; and
assembling said cupped ball toy parts together with respective rim edges thereof abutting together and bonding said ball toy rim edges together to form said ball toy.

7. The method according to claim 6 wherein said housing squeaker receiving hole is formed to extend at an angle to said air vent hole.
